(19) United States
(12) Patent Application Publication
(10) Pub. No.: US 2006/0004567 A1
(43) Pub. Date: Jan. 5, 2006

(54) Method, system and software for teaching pronunciation

(75) Inventor: Thor Morgan Russell, Christchurch (NZ)

Correspondence Address: NIXON & VANDERHYE, PC, 901 NORTH GLEBE ROAD, 11TH FLOOR, ARLINGTON, VA, 22203, US

(73) Assignee: Visual Pronunciation Software Limited, Christchurch (NZ)

(21) Appl. No.: 10/536,385

(22) PCT Filed: Nov. 27, 2003
(86) PCT No.: PCT/NZ03/00261

§ 371 Date: Aug. 29, 2005

(30) Foreign Application Priority Data
Nov. 27, 2002 (NZ) 522798

(51) Int. Cl. G10L 21/00

(52) U.S. Cl. 704/209

(57) ABSTRACT

The present invention relates to a method for teaching pronunciation. More particularly, but not exclusively, the present invention relates to a method for teaching pronunciation using formant trajectories and for teaching pronunciation by splitting speech into phonemes. (A) A speech signal is received from a user; (B) word(s) is/are detected within the signal; (C) voice/unvoiced segments are detected within the word(s); (D) formants of the voiced segments are calculated; (E) vowel phonemes are detected with the voiced segments; the vowel phonemes may be detected using a weighted sum of a Fourier transform measure of frequency energy and a measure based on the formants; and (F) a formant trajectory may be calculated for the vowel phonemes using the detected formants.

### FIELD OF INVENTION

The present invention relates to a method, system and software for teaching pronunciation. More particularly, but not exclusively, the present invention relates to a method, system and software for teaching pronunciation using formant trajectories and for teaching pronunciation by splitting speech into phonemes.

### BACKGROUND OF THE INVENTION

There are many problems in learning a new language; one of the major ones is learning the correct pronunciation of the sounds that make up the language, especially vowel sounds. Often students cannot hear the difference between the sounds that they are making and the sounds that they are trying to produce.

In order to make progress the student first needs to train their ear. This can be time consuming and frustrating for the student if they are only told that their pronunciation is incorrect and are given no feedback on how to correct it.

Once this initial stage has been passed, the student has the problem of not knowing how much of their teacher's pronunciation to copy. The student often will not know whether the differences between their pronunciation and their teacher's are characteristics of the language that they are learning or individual characteristics of their teacher's pronunciation.

There are a number of methods used by existing computer programs to teach pronunciation, including:
1. Describing how to say the sound, showing a mouth picture of how to pronounce a sound, letting the student listen to the teacher, record and hear themselves. Feedback is not given on how the student can improve their pronunciation. Products like these include Pronunciation Power (http://resources.englishclub.com/pp.htm). Explaining how to make a sound is useful, as is letting the student record and compare their speech to a native speaker.
2. The method of (1) and providing an assessment of the student's speech (for example a range assessing the pronunciation from good to bad). “The Learning company” (http://www.broderbund.com/redirect/tic_redirect.asp) with the Learn to Speak English series is an example of a product utilising these methods. An automatic assessment of the student's speech can be useful if it is reliable.
3. Some or all of the above methods and teaching pitch and intonation. Auralog (http://www.auralog.com/en/talktome.html) and BetterAccent Tutor (http://www.betteraccent.com/) seek to do this by showing the student representations of the pitch and loudness for a given word. Pitch and loudness (amplitude) help show intonation (expression) in English speech and can help a non-native English speaker learn this.
4. Showing the waveform or spectrogram of the student's speech compared to the teacher. The idea is that the student will be able to see how they differ, and correct accordingly. Bungalow Software's SpeechPrism (Bungalow http://www.langvision.com/) is an example of this method.
5. Showing the position of the tongue in the mouth using speech recognition, such as VowelTarget by Bungalow Software. This can help a student correct pronunciation errors by giving feedback.
6. Giving feedback on individual words to teach the pronunciation of sentences. TalkToMe by Auralog is an example of this method, and helps teach sentences and correct the student's worst errors by showing the most mispronounced word in a sentence.

However, the above systems have the following associated disadvantages:
1. As this method gives no feedback, the student is not informed precisely what they must do to correct pronunciation errors. Very often learners of English cannot hear the difference between their incorrect pronunciation and the teacher's correct one, so can only make limited progress with such a system.
2. The automatic assessment method is seldom reliable because the student's speech is compared to a specific teacher. Some features in speech are caused by natural variation from speakers and others would be interpreted as pronunciation errors. Automatic assessment cannot distinguish between these effectively and would encourage the student to speak exactly like the teacher, rather than improve their accent. The student's learning is also limited by the same reasons in (1)—they are not given feedback on how to improve their pronunciation.
3. Pitch and intonation are hard to interpret by themselves, they need to be analysed and explained to the user in terms of expression. For example, a plot showing the pitch of a user's voice compared to the teacher's is not valuable if the user is not told that they are practising a question and that pitch should raise at the end of a sentence when practising a question. Without proper interpretation of the pitch and loudness data, a student will find it difficult to know what the significant differences are and which are caused by personal differences and not errors.
4. Waveform and spectrogram displays are not informative for a beginning student who has no knowledge of phonetics. Also, it is not possible to see a large number of pronunciation errors with these displays. As a result students will see differences between their displays and the teacher's that are not related to errors in pronunciation, and miss pronunciation errors that are not clearly shown in the displays. Students will therefore only make limited or no progress in correcting their pronunciation errors by this method.
5. This method attempts to work out the position of the tongue in the mouth without using Formant Trajectories, so does not provide a continuous and physically meaningful plot of where the tongue is. It attempts to find formants 1 and 2, and give this as feedback to the user. Because of the technology they use, the method is not very accurate, giving a native speaker a low score even though the pronunciation may be correct. It also does not distinguish between consonant and vowel sounds, and so cannot provide an accurate indication of where the tongue is in the mouth. Relating formants 1 and 2 to tongue position for consonants gives false results. It also does not give the student the option of replaying their speech, so they are unable to see where they went wrong and train their ear accordingly. Vowel sounds need to be practised in isolation with VowelTarget which also limits the effectiveness of this product.
6. Showing the mispronounced words in a sentence may be useful. However, the TalkToMe product does not give clear, simple instructions to the student on how their pronunciation can be improved. Also, it does not split a word into its constituent phonemes, so students cannot see which part of a word they mispronounced. Therefore, this technology cannot show the student how to improve their pronunciation in terms of tongue position, lip rounding or voicing.

It is an object of the present invention to provide a method for teaching pronunciation which overcomes the disadvantages of the prior art, or to at least provide the public with a useful choice.

### SUMMARY OF THE INVENTION

According to a first aspect of the invention there is provided a method of teaching pronunciation using a display derived from formant trajectories.

The formant trajectories may include those derived from a user's pronunciation or a model pronunciation such as a teacher's.

The user's pronunciation may be recorded and the formant trajectories may be derived from the recorded pronunciation.

The display may be a graph on which the formant trajectory is plotted. Preferably, the trajectory is plotted with a first formant and a second formant form along the two axes of the graph. The graph may be superimposed on a map of the mouth.

It is preferred that the formant trajectories are for vowel phonemes. The vowel phonemes may be extracted from an audio sample of user's/teacher's pronunciation using a weighting method based on frequency.

Preferably, a vocal normalisation method is used to correct the formant trajectories to a norm.

According to a further aspect of the invention there is provided a method of teaching pronunciation, including the steps of:
i) receiving a speech signal from a user;
ii) detecting a word from the signal;
iii) detecting voice/unvoiced segments within the word;
iv) detecting formants in the voiced segments;
v) detecting vowel phonemes within the voiced segments; and
vi) calculating a formant trajectory for the vowel phonemes using the detected formants.

The method preferably includes the steps of comparing the formant trajectory to a model formant trajectory, and using this comparison to provide feedback to the user. The feedback may include feedback based on vowel length, lip rounding, position of the tongue in the mouth, or voicing.

The method may include the step of calculating a score for the user based on any of their average tongue position, start and end tongue position, vowel length, or lip rounding.

The word may be detected by splitting the signal into frames and measuring the energy level in each frame. Preferably, hysteresis is used to prevent bouncing.

The voiced/unvoiced segments may be detected based on a ratio of high to low frequency energy or by using a pitch tracker.

The formants may be detected using Linear Predictive Coding (LPC) analysis.

The vowel phonemes may be detected using a measure derived from Fourier Transform (FFT) of frequency energy, a measure based on the positions of the formants in relation to their normative values, or a weighted combination of both measures.

Preferably, a formant trajectory estimator is used to calculate the formant trajectories. The formant trajectory estimator may use a trellis method.

According to a further aspect of the invention there is provided a method for teaching pronunciation, including the steps of:
i) receiving a speech signal from a user;
ii) detecting a word from the signal;
iii) detecting voice/unvoiced segments within the word;
iv) detecting formants in the voiced segments; and
v) detecting vowel phonemes within the voiced segments by a weighted sum of a Fourier transform measure of frequency energy and a measure based on the formants.

According to a further aspect of the invention there is provided a method of teaching pronunciation, including the step of splitting an audio sample into phonemes by matching the sample to a template of phoneme splits.

The audio sample may be pronunciation of a word or a sentence.

The phonemes may include silence, unvoiced consonant, voiced consonant, or vowel phonemes

Preferably, the sample is matched to the template by splitting the sample up into frames and using a weighted method in conjunction with the template to detect boundaries between the phonemes. The weighted method may be a trellis method. A node within the trellis may be calculated with the following algorithm:
C(t,n)=Clocal(t,n)+min m{Ctran((t,c),(t−1,m))+C(t−1,m)}

The boundaries between two unvoiced phonemes or between two voiced phonemes may be detected by:
i) calculating the Fourier transform of a frame;
ii) calculating the energy in a plurality of intervals within the frequency of the frame;
iii) correlating the energy calculation with the average spectrum of each of the two phonemes; and
iv) determining the boundary as where the correlation of the second phoneme exceeds the correlation of the first phoneme.

The boundaries between two unvoiced phonemes or between two voiced phonemes may be detected by using Mel-Cepstral-Frequency Coefficients.

The boundaries between two voiced phonemes may be detected by:
i) calculating a formant trajectory for the frames comprising the two phonemes; and
ii) determining the boundary as where the formant trajectory crosses the midpoint between the average values of two or more formants for both of the phonemes.

The method preferably includes the step of identifying incorrectly pronounced phonemes. The method may provide feedback to a user on how to correct their pronunciation. The user may select individual phonemes for playback. Feedback may be provided for individual phonemes on correct tongue position, correct lip rounding, or correct vowel length.

According to a further aspect of the invention there is provided a system for teaching pronunciation, including a display device which displays one or more graphical characteristics derived from formant trajectories.

According to a further aspect of the invention there is provided a system for teaching pronunciation, including:
i) a audio input device which receives a speech signal from a user;
ii) a processor adapted to detect a word from the signal;
iii) a processor adapted to detect voice/unvoiced segments within the word;
iv) a processor adapted to detect formants in the voiced segments;
v) a processor adapted to detect vowel phonemes within the voiced segments; and
vi) a processor adapted to calculate a formant trajectory for the vowel phonemes using the detected formants.

According to a further aspect of the invention there is provided a system for teaching pronunciation, including:
i) a audio input device which receives a speech signal from a user;
ii) a processor adapted to detect a word from the signal;
iii) a processor adapted to detect voice/unvoiced segments within the word;
iv) a processor adapted to detect formants in the voiced segments; and
v) a processor adapted to detect vowel phonemes within the voiced segments by calculating a weighted sum of a Fourier transform measure of frequency energy of the voiced segments and a measure based on the formants.

According to a further aspect of the invention there is provided a system for teaching pronunciation, including a processor adapted to split an audio sample into phonemes by matching the sample to a template of phoneme splits.

### BRIEF DESCRIPTION OF THE DRAWINGS

Embodiments of the invention will now be described, by way of example only, with reference to the accompanying drawings in which:

FIG. 1: shows a flow diagram illustrating the method of the invention.

FIG. 2: shows a graph illustrating the effect of bouncing on speech detection.

FIG. 3: shows a graph illustrating the use of hysteresis to prevent the effects of bouncing.

FIG. 4: shows a waveform illustrating a voiced sound.

FIG. 5: shows a waveform illustrating an unvoiced sound.

FIG. 6: shows a graph displaying LPC and FFT spectrums.

FIG. 7: shows a graph illustrating the normal operation of a trellis within the formant trajectory estimator.

FIG. 8: shows a graph illustrating use of a trellis within the formant trajectory estimator when a rogue formants node is ignored.

FIG. 9: shows a graph illustrating use of a trellis within the formant trajectory estimator when a formant node is missing.

FIG. 10: shows a screenshot illustrating the various forms of feedback within a vowel lesson.

FIG. 11: shows a screenshot illustrating feedback for a consonant lesson.

FIG. 12: shows a flow diagram illustrating how a sentence is split up into its constituent phonemes.

FIG. 13: shows a screenshot illustrating how feedback is provided to a user on the constituent phonemes of a sentence.

### DETAILED DESCRIPTION OF PREFERRED EMBODIMENTS

The present invention relates to a method of teaching pronunciation by using formant trajectories and by splitting speech into phonemes. The invention will be described in relation to a computerised teaching system to improve the pronunciation and listening skills of a person learning English or any other language as a second language.

It will be appreciated that the invention may be used for improving the pronunciation and listening skills of a person in their native language, or for improving the pronunciation of the Deaf, with appropriate modifications.

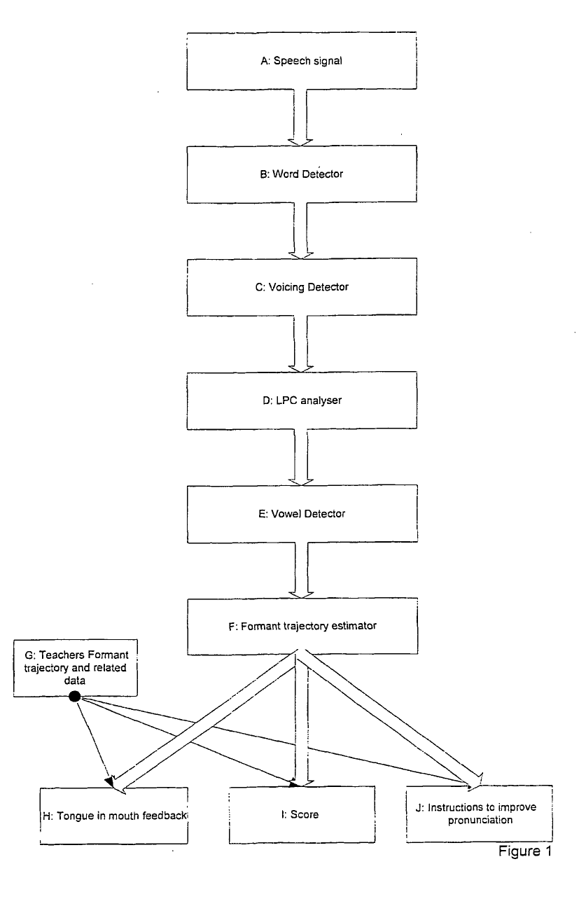

The method of the invention will now be described with reference to FIG. 1.

A: The Speech Signal

Speech from a user or teacher is provided as input to a computer implementing the method via a typical process, such as through a microphone into the soundcard of the computer. Other ways of providing input may be used, such as pre-recording the speech on a second device and transferring the recorded speech to the computer.

B: The Word Detector

This step determines where a word within the speech signal starts and ends.

Firstly, the speech signal is divided into small 5 millisecond (ms) frames.

Secondly, the energy in each frame is calculated.

Lastly, dependent on the energy, the frame is classified as either most likely silence or speech.

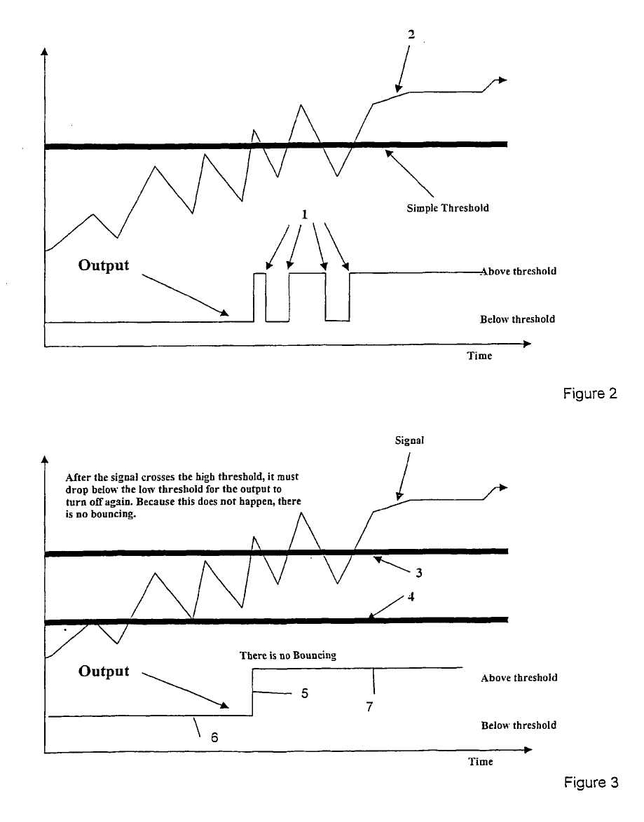

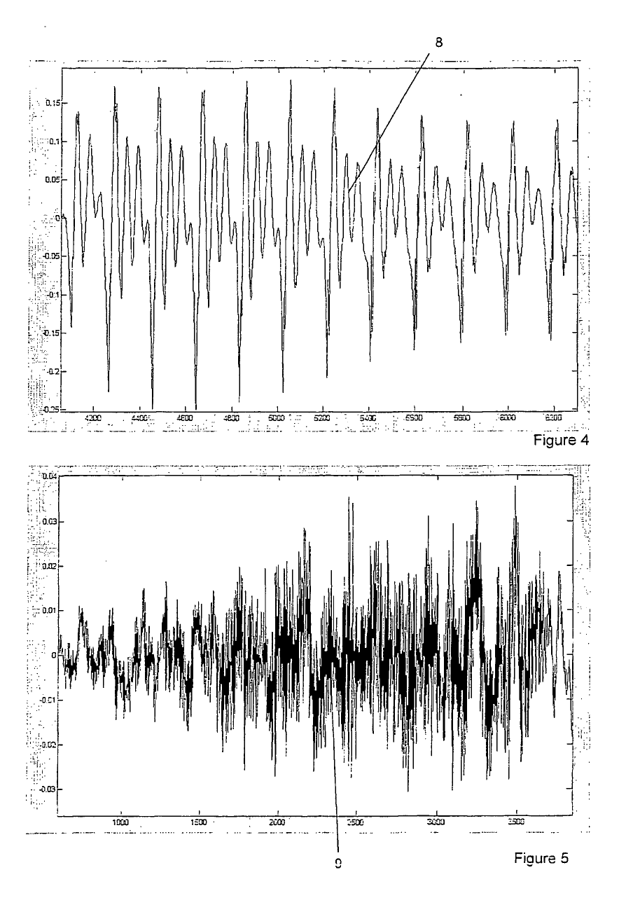

Hysteresis is used to stop the phenomenon known as bouncing—often caused by a noisy signal. FIG. 2 shows how bouncing 1 affects the detection of speech elements within a signal 2. FIG. 3 shows how the hysteresis high 3 and low 4 thresholds are used to eliminate the effect of bouncing and assist the correct identification of boundaries 5 between silence 6 and speech segments 7.

When speech within the signal is present, the word detector will identify one or more words for consideration.

The word detector transmits word segments of length greater than 40 ms to the voicing detector.

C: The Voicing Detector

The voicing detector step determines where voicing begins and ends within a word.

The vocal folds in the voice box vibrate to produce voiced sounds. The speed at which they vibrate determines the pitch of the voice. Sounds in English can either be classified as voiced or unvoiced. Sounds such as “e” and “m” are voiced. Singing a note is always voiced. Examples of unvoiced sounds are “s” as in “seat” and “p” as in “pear”. A sound like “see” is comprised of “s”, which is unvoiced, and “ee”, which is voiced. There is a clear transition from where the speech sound goes from unvoiced to voiced.

The vibrations of the vocal folds in voicing produce a periodic speech waveform, this can be seen as a regular repeating pattern 8 in FIG. 4. In contrast, for an unvoiced sound, there is no pattern, and the speech waveform 9 appears more random. This is shown in FIG. 5.

The voicing detector first splits the speech up into small frames of about 5 mS. Each frame is then classified as either voiced or unvoiced. There are several existing methods of determining classification. Vocoders in cell phones commonly use voicing as part of a technique to compress speech. One method utilises the ratio of high to low frequency energy. Voiced sounds have more low frequency energy than unvoiced sounds do.

Another method is by using a pitch tracker as described in:
YIN, a fundamental frequency estimator for speech and music
Alain de Cheveigne'
Ircam-CNRS, 1 place Igor Stravinsky, 75004 Paris, France
Hideki Kawahara
Wakayama University

When frames have been classified as either voiced or unvoiced, a hysteresis measure, similar to that described in stage (B), is used to find where voicing begins and ends.

D: The LPC Analyser

LPC (Linear Predictive Coding) analysis is used for analysing speech sounds.

The human vocal tract can be approximated as a pipe, closed at one end and open at the other. As such it has resonances at the 1^{st}, 3^{rd}, 5^{th}, etc harmonics. These resonances of the vocal tract are known as formants, with the 1^{st}, 3^{rd}, and 5^{th} harmonics known as the 1^{st} 2^{nd} and 3^{rd} formants. The frequencies of these formants are determined largely by the position of the tongue in the mouth, and the rounding of the lips. It is the formants that characterise vowel sounds in human speech. Changing the tongue position has a fairly direct result on the formant frequencies. Moving the tongue from the back to the front of the mouth causes the second formant (F2) to go from a low to high frequency, moving the tongue from the bottom to the top of the mouth causes the first formant (F1) to go from high to low frequency.

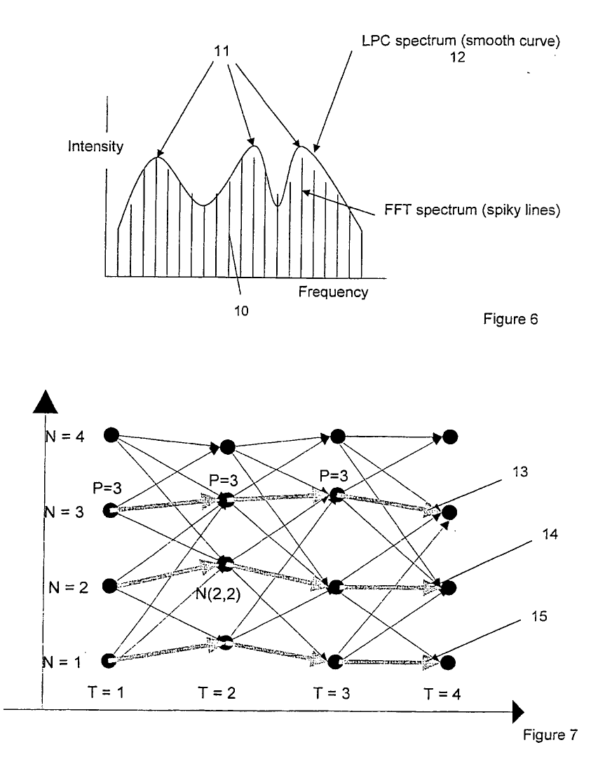

The production of voiced speech starts in the vocal cords. These vibrate periodically, producing a spectrum 10 consisting of lines, shown in FIG. 6. The lines are at multiples of the frequency at which the vocal cords vibrate, and are called the harmonics of this frequency. The frequency of vibration of the vocal cords determines the pitch of the voice, and is not directly related to formants. The sound produced by the vocal cords then travels up through the mouth and out the lips. This is where the formants are generated. The broad peaks 11 (as opposed to the sharp lines) seen in the spectrum 12 in FIG. 6 are caused mainly by the position of the tongue in the mouth and the rounding of the lips. Note that these peaks, or formants, are caused by resonances of the vocal tract that are above the vocal cords, and are independent of their frequency of vibration and hence the pitch of a speaker's voice. Changing the pitch of speech changes the distance between the lines on the spectrum shown in FIG. 6, but does not change the position of the peaks. This is consistent with everyday understanding of speech, as it is possible to alter the pitch of a vowel sound without changing what vowel sound is heard. Singing many notes on a single word is a clear example of this.

LPC (Linear Predictive Coding) is a form of model based spectral estimation. It assumes a physical model and tries to best fit the data to that model. The model it assumes is a decaying resonance or “all pole” model. This matches the situation with speech, where the energy is supplied by the vocal cords, and then resonates through the rest of the vocal tract losing energy as it goes. There is one parameter to alter in the LPC model, this is the number of coefficients returned by the model. These coefficients correspond to resonances or “poles” in the system. Resonances show up as peaks in the spectrum 12, as shown in FIG. 6. The number of resonances in the model are chosen to match the number of resonances in the system being modelled. The real world resonances that are being modelled are the formants.

Digitised speech is provided as input at a sampling rate of 11025 Hz. The average frequencies for the first six formants are approximately 500, 1500, 2500, 3500, 4500, and 5500 Hz. Speech sampled at 11025 Hz gives information on frequencies up to half of 11025 Hz, or 5512 Hz. The first six formants will therefore normally be detectable in speech sampled at this rate. In order to find six resonances, twelve poles are needed in the LPC model. It should be noted that different numbers of poles could be used depending on the situation; in this system using 12 poles gives the best results, with slightly better performance than using 10, 11, 13 or 14. Twelve poles correspond to thirteen coefficients. With normal data, the higher formants are much harder to find than the lower frequency ones. This is because there is less energy in the higher frequencies, and more noise to interfere with the data. It is normal to be able to track the first three to four formants. The LPC model will make an estimate of the higher formant's frequencies, but will quite often be not at all accurate.

In order to begin analysis the method splits the signal into 20 mS frames, overlapping by 5 mS each time. Each frame is then pre-emphasised by differentiating it to increase the accuracy of the LPC analysis.

The 20 mS speech frame is then entered into the LPC model. The twelve coefficients returned are found using a common mathematical technique called Levinson-Durbin Recursion. These coefficients in theory will correspond to the formants in the speech signal. The spikes caused by the harmonics of the vocal cord vibrations will not affect the LPC model, as there are far more of them then there are poles in the model, and because LPC gives preference to larger, more spread out characteristics such as formants.

LPC is called spectral estimation because a spectrum can be derived from the coefficients returned from the model. A common way of doing this is making a vector out of the coefficients, adding zeros to the end of it for increased resolution, and taking the Fourier Transform of this vector. Very often, this spectrum 12 looks quite different from the usual Fourier Transform (FFT) spectrum. This can be seen in FIG. 6, where the LPC spectrum 12 is much smoother than the FFT spectrum 10. This smoothness is because the twelve parameters used in the model can only model six resonances, those of the formants, and the spikes caused by harmonics of the vocal cords are removed from the spectrum. The formants can be estimated by this smoothed spectrum by choosing the peaks, however this may not always be successful, and a slightly different method is used by the invention.

Let the twelve coefficients return by the LPC analysis be labelled A0-A12. Consider the polynomial:
A0+A1*X+A2*Xˆ2+ . . . +A11*Xˆ11+A12*Xˆ12

All polynomials with thirteen coefficients have twelve roots; these can be real or complex. An appropriate root finding algorithm finds all twelve roots of this polynomial; there are many well-known root finding algorithms in the mathematics literature. It is usually the case for voiced speech data that all of the roots are complex, these complex roots will then correspond to the formants. If there are real roots, then it will mean that some of the formants have been missed by the LPC analysis. Complex roots always come in pairs, a negative and positive half. This shows why twelve complex roots are needed to find six formants. The angle or phase of a complex number multiplied by the sampling rate and divided by 2*Pi gives the formant frequency:
(Angle*Sampling Rate/(2*Pi))

It will be appreciated that there are several, slightly differing methods of using LPC to find the formants that may also be used.

E: The Vowel Detector

This step separates voiced consonants from vowels.

Two measures are used for this:
i) a measure based on the Fourier transform (FFT); and
ii) a measure based on the LPC coefficients found in Stage (A).

The FFT measure is split into two parts—one measuring the energy between 1650 and 3850 Hz, and the other a weighted sum of frequencies over 500 Hz.

Vowel sounds have high energy in the range 1650-3850 Hz, compared to consonants. For the weighted sum, a low value corresponds to consonants such as nasals (m,n,ng as in Sam, tan rung), a medium value corresponds to vowels, and a high value corresponds to voiced consonants called fricatives, which include sounds such as “z” in “zip” and “v” in “view”. Low values and high values are judged to be consonants and medium values are judged to be vowels.

The LPC measure is based on the position of Formants one (F1) and two (F2).

A score for F1 is calculated to be (F1−400 Hz).

A positive score means the frame is likely to contain a vowel. A negative score indicates that the frame is likely to contain a consonant.

The score for F2 is positive when absolute value (F2−1225)>600 Hz.

The total LPC classifier is a weighted sum of these two scores. The LPC and FFT measures are then combined in a weighted sum to give an estimate of whether a particular frame is a vowel or a consonant.

It is preferred that the weighted combination of both the FFT and LPC measures are used to determine the vowel-consonant status of a frame. However, either of the FFT measure or the LPC measure may be separately used to determine the status of the frame.

A hysteresis measure is applied to the frames to find where the vowel-consonant boundary occurs.

F: The Formant Trajectory Estimator

Within this step, formant estimates calculated during the LPC analyser step are connected up into meaningful trajectories. The trajectories are then smoothed to give a realistic and physically useful plot of where the tongue is in the mouth. The trajectories of the first three formants must be located within a trellis of possibilities.

Referring to FIG. 7, the method by which formant trajectories are located within the trellis will be described.

The method utilises a cost function that is dependent on the formant values and their derivative from one frame to the next. Formants can only change so quickly with time, and preference is given to those that change more slowly.

For each time interval the first four candidate formants are used as possibilities for the three formant trajectories.

At each node the cost is given by
C(t,n)=Clocal(t,n)+min m{Ctran ((t,n),(t−1,m))+C(t−1,m)}

Clocal is the cost given to the current node; it is a linear function of the bandwidth of the formant, and the difference between the formant and its neutral position. The neutral positions for each of the first three formants are 500, 1500, and 2500 Hz.

Ctran is the transition cost; this is the cost associated with a transition from one node to the next. The function is dependent on the difference in frequencies between the two nodes. The cost is a linear function of the difference, for differences less than 80 Hz/msec. This is the maximum that it is physically possible for the formants to move. When the difference is greater than 80 Hz/msec, the cost is assigned a much greater value, ensuring that the transition is not chosen, and a “wildcard” trajectory is chosen instead if there is not other choice.

A formant trajectory which minimises the total cost is selected through the trellis.

Therefore each node will chose as its predecessor the previous node that minimises its cost function C. The bold lines 13, 14 and 15, within FIG. 7 are the trajectories chosen with minimum cost.

Ctran (the transition cost) is lowest for previous nodes closest in frequency to the current one.

There are two problems that can cause a formant trajectory estimator to produce errors.

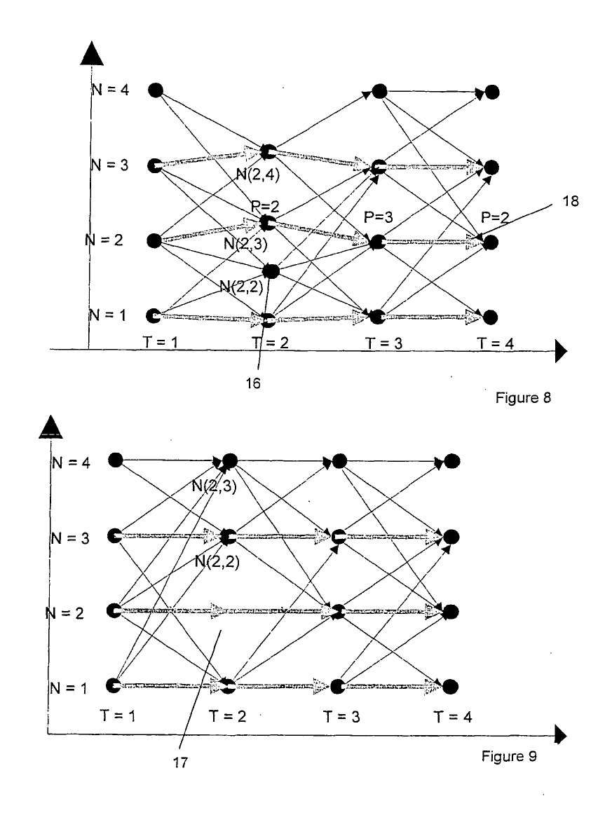

The first is when the LPC analysis indicates there is a formant that is not actually there 16. An example of this is shown in FIG. 8.

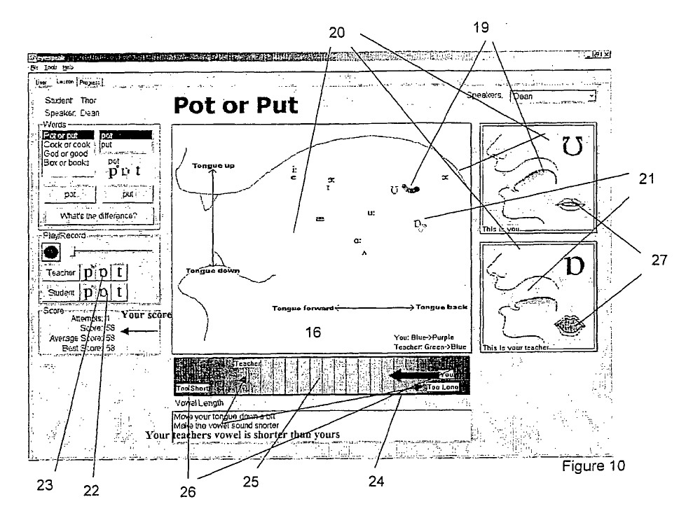

The second is when the LPC analysis misses a formant that is present 17, as shown in FIG. 9.

Each of these problems could potentially cause a formant tracker to lose the trajectory, and cause gross errors. The method eliminates both of errors shown in FIGS. 8 and 9.

In FIG. 8, the formant at time T=2, N=2 is inserted in error. This formant does not correspond to correct information about the position of the tongue and should be ignored. It can be seen that it is ignored because the bold arrows 18 representing the trajectory do not pass through it. This occurs because at time T=2, the minimum weights are for nodes 1, 3, and 4, so these are chosen by the formant tracker. At time T=3, nodes 1, 2, and 3, are again minimum weight so they are chosen. The erroneous formant at time T=2, N=2 is ignored as required.

In FIG. 9, the formant that should be at time T=2, N=2 is missing 17. When the formants are assigned to the nodes, N(1,3) is assigned to N(2,2), and N(1,1) is assigned to N(2,1). The formant in line with T=2, N=3 in the diagram is labelled at T=2, N=2.

N(2,3) is not assigned as there is no physically possible predecessor to it.

At time T=3, there is no possible candidate to become before node T=2, N=2, as T(2,1) and T(2,2) are already assigned to T(3, 1) and T(3,3) respectively, and T(1,4) is not physically possible. In this case, Node (T=3, N=2) is assigned the cost from the last allowable Node 2 trajectory, which was at time T=1, plus a “wild card” cost penalty. The consequence is that the trajectory keeps T=1, N=2 as a “best guess” at the value for T=2, N=2 producing a sensible formant trajectory.

When all the nodes, corresponding to formants in a vowel sound have been assigned a cost, the formant trajectories shown as bold lines on the diagrams are found by backtracking. This means that the three nodes with the lowest scores at the end of the trajectory are taken to be the ends of the three formant trajectories. The rest of the formant trajectories are found by backtracking from the end to the beginning of the vowel sound. This backtracking is possible because for each node, C(t,n), the predecessor node C(t−1,n) is recorded. The previous nodes are then obtained from the present nodes until the whole formant trajectory is obtained.

Additional information about formant trajectory estimators can be found in:
A NEW STRATEGY OF FORMANT TRACKING BASED ON DYNAMIC PROGRAMMING
Kun Xia and Carol Espy-Wilson
Electrical and Computer Engineering Department, Boston University
8 St. Mary's St., Boston, Mass., USA 02215
www.enee.umd.edu/˜juneja/00832.pdf
   G: The Teachers Speech Data

The next step of the method is to compare the student's pronunciation with a model pronunciation such as a teacher's. The teacher's speech is recorded, along with the start and stop times of each phoneme, the formant trajectories where appropriate, and the teacher's vocal tract length (discussed below). This information is compared to similar information for the user and feedback is provided on vowel length, lip rounding, and the position of the tongue in the mouth. Feedback is provided for each phoneme.

H: Feedback on Tongue Position, Vowel Length, and Lip Rounding

FIG. 10 shows how feedback is provided for vowel phonemes.

Formants 1 and 2 are used to show the position 19 of the top of the tongue in a 2-D side-on view 20 of the mouth. As the tongue goes from the back to the front of the mouth, F2 goes from low to high, as the tongue goes from the top to the bottom of the mouth, F1 goes from low to high.

It will be appreciated that a virtual 3-D model viewable from any angle may be used instead.

The student's tongue position is shown with a coloured trace 19, changing from blue to purple as time increases, and the teacher's with a green to blue trace 21. Both traces are shown against the background of a map of the inside of a mouth 20.

It will be appreciated that an alternative optical characteristic such as increasing density of pattern may be used to show the change of a formant trajectory with time.

Another important method of providing feedback is where the user can both hear the sound and see the position of the tongue in the mouth at the same time. To do this, the student either selects with the computer mouse their vowel 22 or the teacher's vowel 23. They can then see a trace of the position of the tongue in the mouth, synchronised with the vowel sound that is being played back to them. This trains the student's ear, helping them associate sounds with the position of the tongue in the mouth, and hence what sound was made.

Vowel length is shown in FIG. 10, with the student's vowel length compared to the teacher's on a bar 24. The allowable range of correct vowel lengths is shown as a green area 25, with red 26 either side meaning the vowel was outside the acceptable range. Lip rounding is determined by the third Formant (F3), and the difference between F3 and F2. When the lips are ungrounded, such as when smiling, F3 is higher and there is greater distance between F2 and F3 than when they are rounded. This information can be given to the student as either pictures 27 showing how their lips were rounded and how their teacher's lips were rounded, or as instructions telling the student to round their lips more or less.

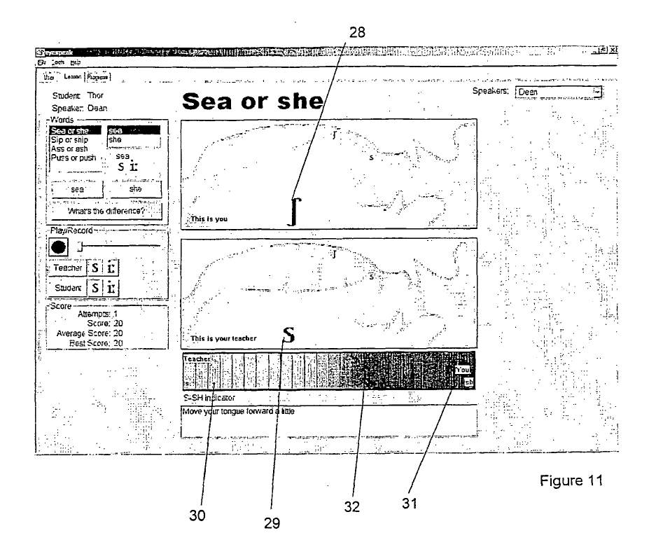

It is not possible or meaningful to show the vowel plot for consonant lessons. Feedback for consonant phonemes is shown in FIG. 11, where the system indicates what phoneme 28 it classified the user's speech as, compared to what the correct phoneme 29 is supposed to be. This classification can be done using FFT frequency correlation or Mel-Cepstral-Frequency Coefficients to classify unvoiced consonants, or formant trajectories as well as these two methods to classify voiced consonants.

When the system classifies a phoneme as being different to what is in the template, it can show how far it was from the desired phoneme with the green 30 to red 31 bar 32 near the bottom of FIG. 11. Sounds further to the right, in the red 31 are less well pronounced than those to the left in the green 30. In FIG. 11, the system classified the users speech as a “sh” sound when an “s” sound was required. Therefore “You” representing the user's speech is at the far right of the bar. As “s” is the required phoneme, the “s” symbol is at the far left of the bar in the green 30, whereas the “sh” sound is at the far right in the red area 31.

Vocal Tract Length Normalisation

For a given vowel sound, formants 1-3 are about 20% higher in frequency for females than they are for males. This is because the female's vocal tract is shorter than males. Unless this is corrected for, a male and female's vowel sound, even if it is the same, will be plotted wrongly by this system. There is also slight variation in vocal tract length within sexes, especially for younger children. There are two ways around this, the first is to compare males to males and females to females, and the second is to estimate the teacher and student's vocal tract length using speech recognition technology, and correct for it. A reasonable method of estimating the user's vocal tract length is by recording the user saying “aaa”, measuring the average frequency of the third formant and dividing it by 5. This can then be used to normalise for small variations in vocal tract length between speakers and give increased accuracy in the vowel plot.

I: The Score

For a vowel, the score compares the following parameters of the student to the teacher:
1. The average tongue position
2. The start and end tongue position
3. The vowel length
4. The lip rounding

This gives the student a general indication of the quality of their pronunciation, and how much they are improving. Parameter 2, the start and end position, is of particular importance for diphthongs and is given a higher weighting for lessons concentrating on teaching diphthongs.

J: Instructions to the Student on How They Can Improve Their Pronunciation

Further feedback is given to the user on how they can improve their pronunciation in the form of written instructions. These instructions duplicate the visual feedback and are given because some users prefer to learn language with instructions, others by visual displays, and others by being able to listen and compare. The instructions given are instructions such as: make the vowel sound shorter/longer, start/end the sound with your tongue higher/lower/forward/back in your mouth, round your lips more/less. For a consonant such as the “th” sound, an instruction could be ‘check your tongue is between your teeth when making the “th” sound’.

In teaching pronunciation, it would be helpful if the user's pronunciation of a word or sentence is split into its constituent phonemes, so the user can select their individual phonemes for playback, feedback, or analysis.

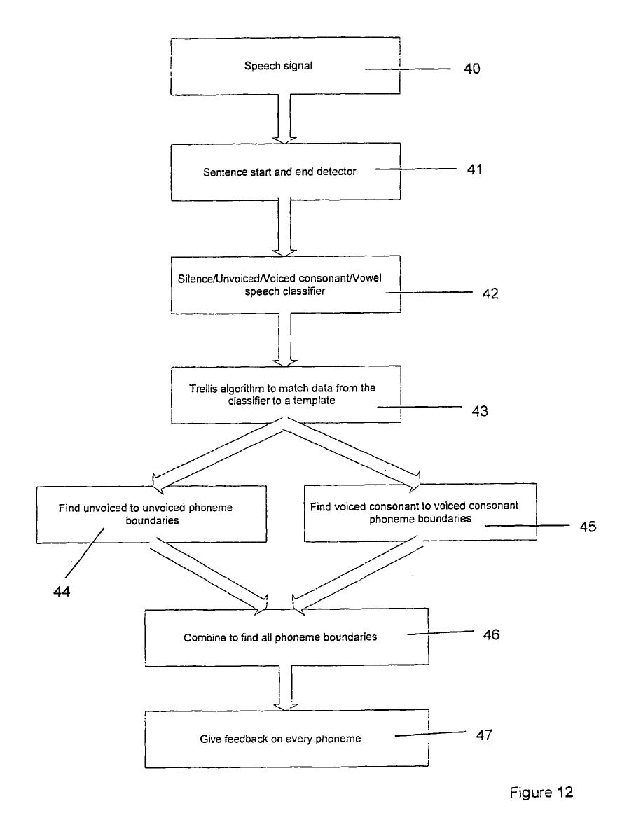

The splitting of a sentence into phonemes will now be described with reference to FIG. 12

Stages (A) to (E) above describe various techniques for detecting a word from silence, splitting a word into its unvoiced/voiced parts, and for splitting a voiced sound into consonant and vowel sounds. These techniques can be combined to detect the state of each frame—whether it is silent, an unvoiced consonant, a voiced consonant or a vowel. These are shown in steps 40, 41, and 42 in FIG. 12. When the method is splitting a sentence rather than a word, the use of stage (C) for step 41 is modified to identify when a sentence starts and stops. Approximately 100 ms of silence is needed before the beginning and after the end of the speech to be certain that the entire sentence has been chosen for analysis. There can be silent gaps in normal sentences that do not mean the sentence has finished. These 100 ms silent intervals are ignored for the following analysis.

In step 43, the boundaries where the speech changes from one of the four states are determined. For the purposes of the following example, S=silent, UV=unvoiced consonant, VC=voiced consonant, and V=vowel.

Consider the sentence—“a short sentence”.

This could be split up into the following template of phonemes:

| | | | | | | | | | | | | |
|---|---|---|---|---|---|---|---|---|---|---|---|---|
| A | | sh | or | | ts | e | n | | t | e | n | ce |
| V | S | UV | V | S | UV | V | VC | S | UV | V | VC | UV |

The sounds are classified as V/VC/UV, with silences shown as appropriate.

The method matches a real speech sound to the above classification by the following steps:

It may take 1.8 seconds to say “a short sentence”. The speech is split up into 12 mS frames, 150 in this case. It is desired to match these 150 frames to a template consisting of the classifications shown above, namely:

| V - S - UV - V - S - UV - V - VC - S - UV - V - VC - UV | | | | | | | | | | | | |
|---|---|---|---|---|---|---|---|---|---|---|---|---|
| 1 | 2 | 3 | 4 | 5 | 6 | 7 | 8 | 9 | 10 | 11 | 12 | 13 |

In a method similar to the formant trajectory estimator in stage (F), a trellis and cost function at each node is used to find the most likely boundaries. A 150 by 13 trellis is needed to hold all the nodes.

The following formula, which is dependent on the local cost, the transition cost, and the cost of the node to transition from, is used to update the weights at each node:
C(t,n)=Clocal(t,n)+min m{Ctran ((t,n),(t−1,m))+C(t−1,m)}

Transitions are only permitted from C(t−1,n−1) and C(t−1,n) to C(t,n).

This means that the next node can either have the same phoneme as the last one, or one later in the template. If the next node had a phoneme two steps further on in the template, then it would mean that the phoneme in between was missed out, and this is not permitted.

Clocal in this case is a measure of how well the node matches the template. For example if a node was being compared to an unvoiced phoneme in the template, then the cost Clocal would depend on how unvoiced that node was. If the node was judged as being mainly voiced/vowel/or silent, then there would be a high cost.

Ctran is determined by the length of the previous phoneme. There are usual lengths for each phoneme, for example 20-40 ms for a particular consonant. If the length was greater or less than this, then there would be a high transition cost associated.

Initialisation and Backtracking

At the first node, the number in the template to start at is 1, i.e. the sound starts off being unvoiced. To do this, C(T=1,N=1) is set to 0, and C(T=1,N>1) is set to a very large negative number, indicating a large cost. Backtracking begins at N(T=1150, N=13), this means that the last node must correspond to the last phoneme in the template. Backtracking then proceeds as in stage (F) and finds the positions of the most likely phoneme boundaries.

Finding Additional Phoneme Boundaries that are not Found by the Trellis Method

If two or more unvoiced phonemes or two or more voiced consonants occur consecutively, then the previous method will not find all the phoneme boundaries. Other methods are needed.

The boundaries between unvoiced and unvoiced phonemes are detected in step 44 as follows:

Considering the word “fixed” as an example, the “xed”, represented by sounds “k-s-t”, appears impossible to split with this method. However, it is possible to find the boundary between “ks” and “t” because there is a silence between them.

Splitting up clusters like “ks” or “ps” in “whips” requires another method however.

One method involves computing the Fourier transform of each frame, and calculating the energy in each 200 Hz interval, and correlating this with the average spectrum of the two sounds. In the case of “ks” each frame would be correlated with an average spectrum of “k” and “s” and the boundary would be taken where the “s” correlation first exceeded the “k” correlation.

Another method involves using Mel-Cepstral Frequency Coefficients, a commonly used tool in speech recognition, on each frame, and a similar distance measure based on averaged coefficients to find the boundary.

A method based on a combination of these could also be used.

Boundaries between voiced and voiced phonemes are detected in step 45 as follows:

Considering the word “present” as an example, in many circumstances, “sent” would sound like “z-n-t” with no vowel in between the “z” and “n”. It is possible to use Mel-Cepstral-Frequency Coefficients, an FFT based correlation measure, or a method based on formants to find the boundary, or any combination of these methods. The formant based method would calculate a formant trajectory for the sound “zn”. The average value of formants 1-3 is different for “z” and “n”. The boundary between the two sounds occurs where the trajectories cross the midpoint between these two averages.

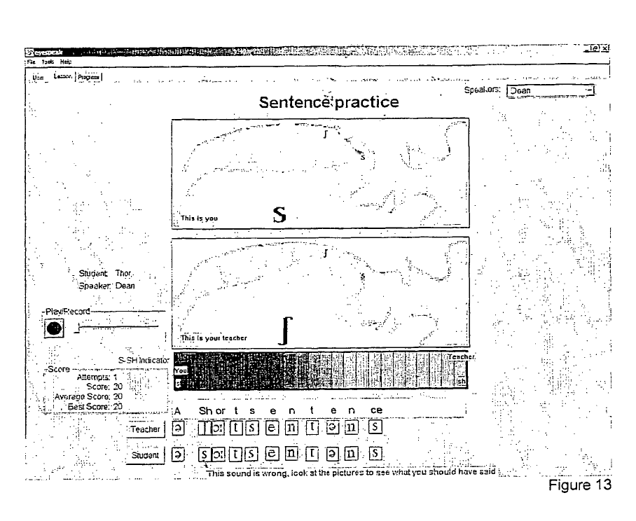

All the methods are combined in step 46 to split any English sentence into its constituent phonemes. FIG. 13 shows how the phonemes can be assessed and displayed to the user. If the user fails to pronounce a phoneme, or pronounces it for the wrong length, then, in step 47, the method will tell the user that the computer heard that phoneme for the wrong length, and give the user feedback on how they can improve. Feedback can include the methods used in stage (H).

The present invention is an improvement over previous technology because it shows the user in a clear, simple and accurate way that their pronunciation is different to a native speaker, and what the user can change to correct it. It does this using by using formant trajectories to estimate the position of the tongue in the mouth for vowel sounds. The position of the tongue in the mouth is a strong indicator of whether a vowel has been pronounced correctly. The method of tracking the position of the tongue in the mouth is unique to this invention and it gives this invention a significant advantage over existing technologies because it frees the student from comparison of their pronunciation with the idiosyncrasies and individual characteristics of a single teacher's mode of speaking. The option of playing back the sound while seeing how the tongue moves in real time is unique to this invention, and very useful.

In addition, the ability to teach sentences is important for a language teaching tool. To give effective feedback to the student it is necessary to split up the attempt they made into its phonemes, show them where they went wrong, and how they can improve the pronunciation of each sound with simple effective instructions.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1-77. (canceled)

78. A method of teaching pronunciation using a display derived from formant trajectories of vowel phonemes.

79. A method as claimed in claim 78 wherein the formant trajectories include those of a user's pronunciation.

80. A method as claimed in any claim 79 wherein the user's pronunciation is recorded and may be played back.

81. A method as claimed in claim 79 wherein the user's pronunciation is recorded and at least some of the formant trajectories are derived from the recorded pronunciation.

82. A method as claimed in claim 79 wherein the formant trajectories include those of a model pronunciation.

83. A method as claimed in claim 79 wherein the display includes a graph with a first formant-derived value along one axis and a second formant-derived value along a second axis and wherein the first and second formants are the two lowest formant frequencies.

84. A method as claimed in claim 83 wherein the formant trajectory is plotted on the graph and the formant trajectory plot changes in an optical characteristic in relation to time.

85. A method as claimed in claim 84 wherein the graph is superimposed on an image of the mouth.

86. A method as claimed in claim 85 wherein the vowel phonemes are isolated from an audio sample using a weighting method based on frequency.

87. A method as claimed in claim 86 wherein a vocal tract normalisation method is used to correct the formant trajectories to a norm.

88. A method of teaching pronunciation, including the steps of:
i) receiving a speech signal from a user;
ii) detecting a word from the signal;
iii) detecting voice/unvoiced segments within the word;
iv) detecting formants in the voiced segments;
v) detecting vowel phonemes within the voiced segments; and
vi) calculating a formant trajectory for the vowel phonemes using the detected formants.

89. A method as claimed in claim 88 including the steps of:
vii) comparing the formant trajectory to a model formant trajectory; and
viii) using the comparison to give feedback to the user.

90. A method as claimed in claim 89 wherein the comparison includes the comparison between the length of the user's vowel phonemes and the length of model vowel phonemes.

91. A method as claimed in claim 90 wherein the feedback includes one or more from the set of vowel length, lip rounding, position of the tongue in the mouth, and voicing.

92. A method as claimed in claim 91 wherein the feedback includes instructions assisting correct pronunciation.

93. A method as claimed in claim 92 wherein the word is detected from the signal by splitting the signal into frames, calculating the energy in each frame, and classifying the frame as either silence or speech.

94. A method as claimed in claim 93 wherein a hysteresis algorithm is used to prevent bouncing.

95. A method as claimed in claim 93 wherein the voiced/unvoiced segments are detected based on the ratio of high to low frequency energy.

96. A method as claimed in claim 95 wherein the voiced segments are split into frames and the frames are overlapping with each other.

97. A method as claimed in claim 95 wherein the vowel phoneme is detected using a Fourier transform measure of frequency energy

98. A method as claimed in claim 97 wherein the Fourier transform measure is comprised of measuring the energy between about 1650 and about 3850 Hz, and the weighted sum of frequencies over about 500 Hz.

99. A method as claimed in claim 95 wherein the vowel phoneme is detected using a formants measure comprised of a weighed sum of (a) a first score derived from the difference between a first formant and a norm, and (b) a second score derived from the difference between a second formant and a norm.

100. A method as claimed in claim 99 wherein detection of the vowel phoneme includes the use of a hysteresis measure to detect the boundaries of the phoneme.

101. A method as claimed in claim 95 wherein the vowel phoneme is detected using a weighted sum of a Fourier transform measure of frequency energy and a Linear Predicative Coding (LPC) analysis of the formants.

102. A method as claimed in claim 95 wherein a formant trajectory estimator is used to calculate a formant trajectory and the formant trajectory estimator includes the use of a weighted trellis.

103. A method for teaching pronunciation, including the steps of:
i) receiving a speech signal from a user;
ii) detecting a word from the signal;
iii) detecting voice/unvoiced segments within the word;
iv) detecting formants in the voiced segments; and
v) detecting vowel phonemes within the voiced segments by a weighted sum of a Fourier transform measure of frequency energy and a measure based on the formants.

104. A method as claimed in claim 103 wherein the word is detected from the signal by splitting the signal into frames, calculating the energy in each frame, and classifying the frame as either silence or speech.

105. A method as claimed in claim 104 wherein a hysteresis algorithm is used to prevent bouncing.

106. A method as claimed in claim 105 wherein the Fourier transform measure is comprised of measuring the energy between about 1650 and about 3850 Hz, and the weighted sum of frequencies over about 500 Hz.

107. A method as claimed in claim 106 wherein the formants measure is comprised of a weighed sum of (a) a first score derived from the difference between a first formant and a norm, and (b) a second score derived from the difference between a second formant and a norm.

108. A system for teaching pronunciation, including a display device which displays one or more graphical characteristics derived from formant trajectories of vowel phonemes.

109. A system for teaching pronunciation, including:
i) a audio input device which receives a speech signal from a user;
ii) a processor adapted to detect a word from the signal;
iii) a processor adapted to detect voice/unvoiced segments within the word;
iv) a processor adapted to detect formants in the voiced segments;
v) a processor adapted to detect vowel phonemes within the voiced segments; and
vi) a processor adapted to calculate a formant trajectory for the vowel phonemes using the detected formants.

110. A system for teaching pronunciation, including:
vii) a audio input device which receives a speech signal from a user;
viii) a processor adapted to detect a word from the signal;
ix) a processor adapted to detect voice/unvoiced segments within the word;
x) a processor adapted to detect formants in the voiced segments; and
xi) a processor adapted to detect vowel phonemes within the voiced segments by calculating a weighted sum of a Fourier transform measure of frequency energy of the voiced segments and a Linear Predicative Coding (LPC) analysis of the formants.

111. A computer system for effecting the method of claim 78.

112. A computer system for effecting the method of claim 88.

113. A computer system for effecting the method of claim 103.

114. Computer software for effecting the method of claim 78.

115. Computer software for effecting the method of claim 88.

116. Computer software for effecting the method of claim 103.

117. Storage media containing software as claimed in claim 114.

118. Storage media containing software as claimed in claim 115.

119. Storage media containing software as claimed in claim 116.
